(19) United States
(12) Patent Application Publication
(10) Pub. No.: US 2010/0309118 A1
(43) Pub. Date: Dec. 9, 2010

(54) MULTI-FUNCTIONAL WIRELESS CONTROL DEVICE

(75) Inventors: JIN-MIN HE, Shenzhen City (CN); YONG-JUN ZHOU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ZhenZhen City (CN); FIH (HONGKONG) LIMITED, Kowloon (HK)

(21) Appl. No.: 12/616,326

(22) Filed: Nov. 11, 2009

(30) Foreign Application Priority Data
Jun. 9, 2009 (CN) 200910303098.7

(51) Int. Cl. G06F 3/033; G08C 19/00

(52) U.S. Cl. 345/157; 340/825.69

(57) ABSTRACT

A multi-functional wireless control device includes an operating body and a receiving unit electrically connecting with a digital port of a digital processing device. The operating body includes a shell, a control module, an infrared module, a switch and a transmit module. The shell has remote operating keys and mouse keys disposed thereon configured for inputting the corresponding controlling signals. The control module is assembled within the shell to process the inputting controlling signals and transmit the processed controlling signals to the receiving unit for establishing communication therebetween by the infrared module and/or the transmit module. The switch is configured to select between the remote controlling mode and wireless mouse mode.

### BACKGROUND

1. Technical Field

The exemplary disclosure generally relates to wireless control devices, and particularly relates to a multi-functional wireless control device having integrated mouse and remote control capabilities.

2. Description of Related Art

Display devices such as projectors, liquid crystal display-televisions, etc. are widespread used in meeting rooms, classrooms etc. for providing visual displays. These display devices are often connected to and controlled by computers to implement some complex operations.

Generally, these display devices (e.g. projectors, liquid crystal display-televisions) are often controlled by wireless control devices. However, the wireless control device connected to the corresponding display device cannot control the computer mutually connecting with the display device. As such, other control devices such as mouse and keyboard are needed to control the computer, which may bring inconvenience to users.

Therefore, there is room for improvement within the art.

### BRIEF DESCRIPTION OF THE DRAWINGS

Many aspects of the exemplary multi-functional wireless control device can be better understood with reference to the following drawings. These drawings are not necessarily drawn to scale, the emphasis instead being placed upon clearly illustrating the principles of the exemplary methods. Moreover, in the drawings like reference numerals designate corresponding parts throughout the several views. Wherever possible, the same reference numbers are used throughout the drawings to refer to the same or like elements of an embodiment.

FIG. 1 shows a functional block diagram of a multi-functional wireless control device according to an exemplary embodiment.

FIG. 2 shows a perspective view of the multi-functional wireless control device according to an exemplary embodiment.

FIG. 3 is similar to FIG. 2, but viewed from another aspect.

FIG. 4 shows a schematic diagram of the receiving unit of the multi-functional wireless control device according to an exemplary embodiment.

### DETAILED DESCRIPTION

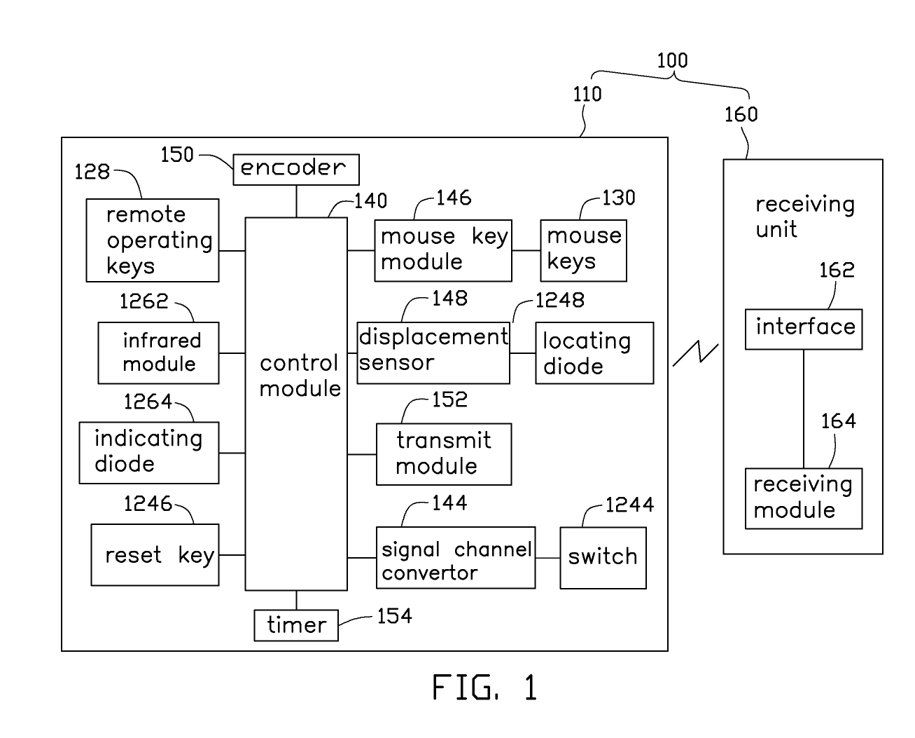

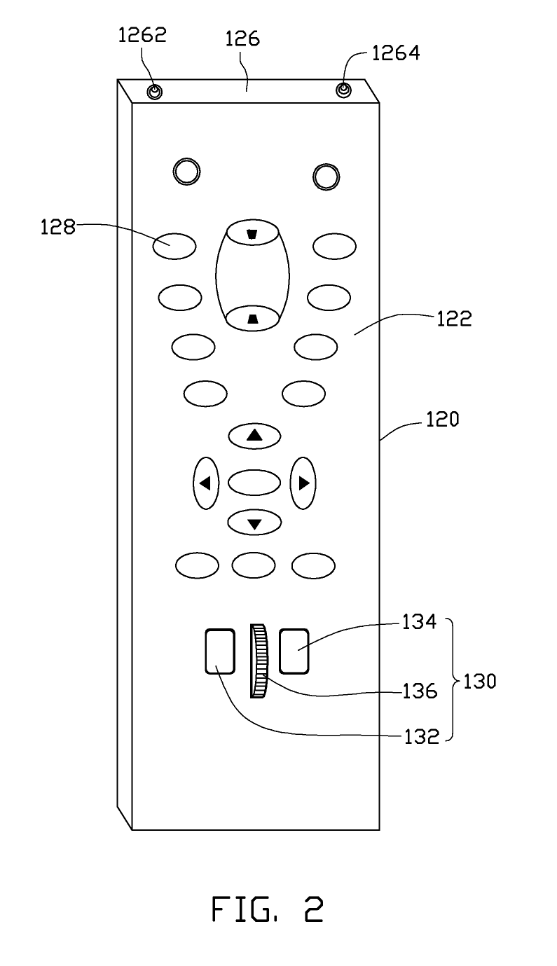

Referring to FIG. 1, a functional block diagram of an exemplary multi-functional wireless control device 100 according to an exemplary embodiment is shown. The multi-functional wireless control device 100 is configured to work in a remote control mode or a wireless mouse mode, whereby, the multi-functional wireless control device 100 can be used as a wireless control device or a wireless mouse. In the exemplary embodiment, the multi-functional wireless control device 100 includes an operating body 110 for use with a receiving unit 160. The operating body 110 includes a shell 120 (shown in FIG. 2), a control module 140 and a processing unit (not labeled). The control module 140 and the processing unit are both assembled within the shell 120.

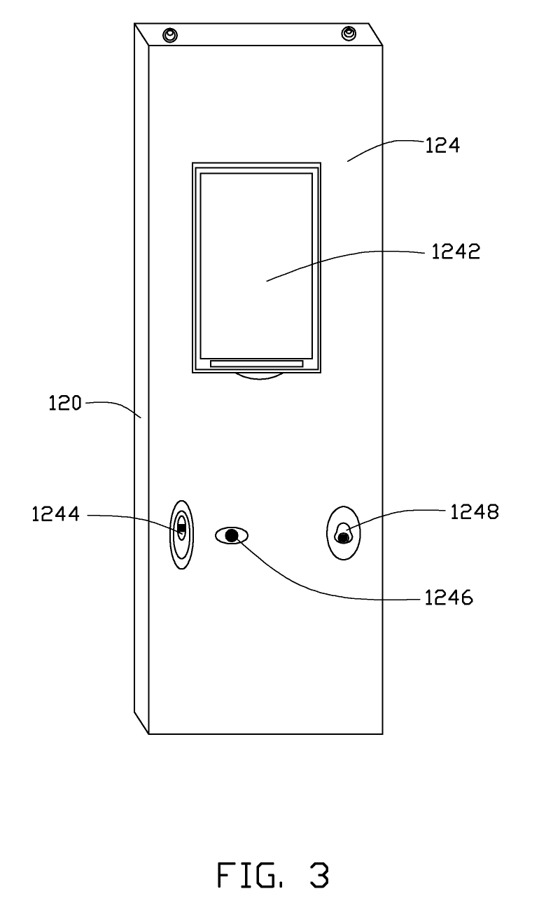

Also referring to FIG. 2 and FIG. 3, the shell 120 includes an upper surface 122, an opposite bottom surface 124 and an end surface 126 disposed therebetween that connecting to the upper surface 122 and the bottom surface 124. The upper surface 122 includes remote operating keys 128 and mouse keys 130 arranged thereon. In use, the remote operating keys 128 and the mouse keys 130 are pressed/operated by a user to generate corresponding controlling signals. The controlling signals are transmitted to the control module 140 to control a digital processing device (e.g. computer, projector, etc.). In the exemplary embodiment, the remote operating keys 128 may include numeric and functional keys such as volume adjusting keys, TV/AV switching key, mute key, off key, etc. The mouse keys 130 may include a left key 132, a right key 134 and a roller 136 disposed between the left key 132 and the right key 134.

The bottom surface 124 may include a battery receiving portion 1242, a switch 1244, a reset key 1246 and a locating diode 1248 thereon. The battery receiving portion 1242 is configured to assemble a battery therein for providing power supply to the multi-functional wireless control device 100. The switch 1244 is configured to be pressed to send out a switching signal to the control module 140 to switch between the remote controlling mode and the wireless mouse mode. The reset key 1246 is configured to reset the wireless mouse mode. The locating diode 1248 is a laser photodiode configured to send out light when working in wireless mouse mode.

The end surface 126 may include an infrared module 1262 and an indicating diode 1264 thereon both electrically connecting with the control module 140. The infrared module 1262 is configured to trigger and communicate with a digital processing device (e.g. computer, projector, etc.) by sending out infrared signals when working in remote controlling mode, for controlling the digital processing device by operating the remote operating keys 128. The indicating diode 1264 is configured to send out visible rays as a projector laser pointer.

The control module 140 and the processing unit are both assembled and disposed within the shell 120. The control module 140 is a digital signal processor (DSP) configured to process and modulate the signals generated by the operating body 110 to control and establish communication between the operating body 110 and the receiving unit 160.

Referring to FIG. 1, the processing unit includes a signal channel convertor 144, a mouse key module 146, a displacement sensor 148, an encoder 150, a transmit module 152 and a timer 154 all electrically connecting with the control module 140. The signal channel convertor 144 electrically connects with the control module 140 and the switch 1244. The signal channel convertor 144 is configured to receive the switching signal generated by the switch 1244 to activate the wireless mouse mode and search for the proper signal channel and communicating frequency. The mouse key module 146 electrically connects with the control module 140 and the mouse keys 130.

The mouse key module 146 is configured to receive the corresponding controlling signals generated by the mouse keys 130 (operated by the operator) and transmit the corresponding controlling signals to the control module 140. The displacement sensor 148 is a laser sensing module electrically connecting with the locating diode 148 and the control module 140. The displacement sensor 148 is configured to sense/detect the shift/movement of the light sent out by the locating diode 1248 to determine the coordinates information of the operating body 110 (used as a wireless mouse) and transmit the shift/movement coordinates information to the control module 140. The encoder 150 electrically connects with the control module 140 and is configured to convert the triggering signals into the wireless transmitting codes to avoid frequency interference and transmission interruptions. The transmit module 152 is a dual band antenna module working in frequency of 27.045 MHz and 27.145 MHz in the exemplary embodiment and is configured to communicate with the receiving unit 160 wirelessly. The timer 154 electrically connects with the control module 140 and is configured to set a time to leave the operating body 110 on standby mode or asleep mode.

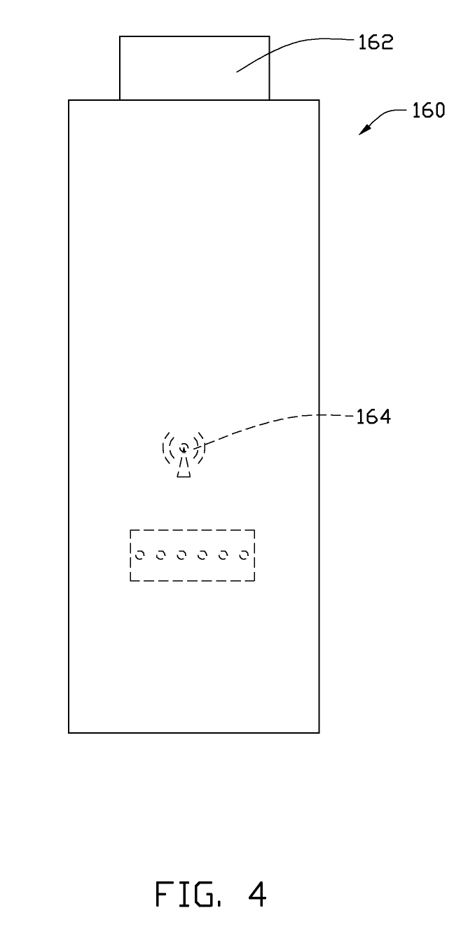

Also referring to FIG. 4, the receiving unit 160 is an attached receiver configured to electrically connect with a digital port of a digital processing device (e.g. computer, projector, etc.) for establishing wireless communication with the operating body 110. The receiving unit 160 includes an interface 162 and a receiving module 164. In the exemplary embodiment, the interface 162 is a USB interface/port. The receiving module 164 is configured to receive the wireless controlling signals sent out by the operating body 110 and transmit the received controlling signals to the digital processing device such as computer by the interface 162.

In use, when the multi-functional wireless control device 100 works in remote controlling mode, the infrared module 1262 and the remote operating keys 128 are used. Then, the user may operate the corresponding remote operating keys 128 of the operating body 110 to trigger and control the digital processing device (e.g. computer, projector, etc.). As the remote operating keys 128 are operated, the controlling signals generated simultaneously are transmitted to the control module 140 for processing. The control module 140 processes the signals and then transmits them to the receiving module 164 of the receive unit 160 by the infrared module 1262, for establishing wireless communication between the operating body 110 and the receiving unit 160. The infrared module 1262 sends out infrared signals to the receiving module 164 of the receiving unit 160, to trigger and control the digital processing device (e.g. computer, projector, etc.).

When the multi-functional wireless control device 100 is needed to work as a wireless mouse, the switch 1244 is operated to choose the wireless mouse mode. Then, the signal channel convertor 144, the mouse key module 146, the displacement sensor 148, the encoder 150, the transmit module 152 and the timer 154 are used. When the multi-functional wireless control device 100 works in wireless mouse mode, the signal channel convertor 144 activates the wireless mouse mode and searches for the proper signal channel and communicating frequency to establish communication between the operating body 110 and the digital processing device (e.g. computer) by the receiving unit 160. When the user moves the operating body 110, the locating diode 1248 sends out light projected on a table to form optical signals. The displacement sensor 148 senses/detects the optical signals generated by shift/movement of the light sent out by the locating diode 1248 and transmits the shift/movement coordinates information to the control module 140. The control module 140 processes the signals and transmits them to the receiving module 164 of the receive unit 160 by the transmit module 152, for controlling the digital processing device. When the user operates the left key 132, the right key 134 and the roller 136 of the operating body 110, the left key 132, the right key 134 and the roller 136 generate the corresponding triggering signals. The triggering signals are transmitted to the encoder 150 to convert the triggering signals into the corresponding wireless transmitting codes and transmit the wireless transmitting codes to the control module 140. The control module 140 processes the signals and transmits them to the receiving module 164 of the receive unit 160 by the transmit module 152, for controlling the digital processing device. The receiving module 164 transmits the wireless transmitting codes to the digital processing device by the interface 162.

It is to be understood that the displacement sensor 148 could also be an infrared sensing module, accordingly, the locating diode 1248 could be an infrared photodiode.

It is to be understood that the interface 162 could be a PS/2 data transmitting port.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-functional wireless control device configured to work in a remote controlling mode or a wireless mouse mode comprising:
a shell having set of remote operating keys and mouse keys disposed thereon configured for inputting corresponding controlling signals;
a control module assembled within the shell configured to process the controlling signals and establish communication with a receiving unit;
an infrared module electrically connecting with the control module and configured to transmit the corresponding controlling signals generated by the remote operating keys to the receiving unit;
a transmit module electrically connecting with the control module and configured to transmit the corresponding controlling signals generated by the mouse keys to the receiving unit; and
a switch configured to change the using module between the remote controlling mode and wireless mouse mode.

2. The multi-functional wireless control device as claimed in claim 1, wherein the transmit module includes a dual band antenna module.

3. The multi-functional wireless control device as claimed in claim 2, wherein the operating body further includes a signal channel convertor electrically connecting with the control module and the switch, the signal channel convertor is configured to receive the switching signal generated by the switch to activate the wireless mouse mode and search for the proper signal channel and communicating frequency.

4. The multi-functional wireless control device as claimed in claim 1, wherein the control module is a digital signal processor.

5. The multi-functional wireless control device as claimed in claim 1, wherein the operating body further includes a mouse key module electrically connecting with the control module and the mouse keys, the mouse key module is configured to receive the corresponding controlling signals generated by the mouse keys and transmit the corresponding controlling signals to the control module.

6. The multi-functional wireless control device as claimed in claim 5, wherein the operating portion further includes an encoder electrically connecting with the control module, the encoder is configured to convert the triggering signals generated by the mouse keys into the wireless transmitting codes to avoid frequency interference and transmission interruptions.

7. The multi-functional wireless control device as claimed in claim 6, wherein the operating portion further includes a locating diode and a displacement sensor electrically connecting with the locating diode and the control module; the locating diode is a laser photodiode configured to send out light when operating in wireless mouse mode; the displacement sensor is a laser sensing module configured to sense/detect the shift/movement of the light sent out by the locating diode to determine the coordinates information of the operating body and transmit the shift/movement coordinates information to the control module.

8. The multi-functional wireless control device as claimed in claim 7, wherein the receiving unit includes an interface and a receiving module, the receiving module is configured to receive the wireless controlling signals sent out by the operating body and transmit the received controlling signals to the digital processing device by the interface.

9. The multi-functional wireless control device as claimed in claim 6, wherein the interface is a USB interface/port.

10. The multi-functional wireless control device as claimed in claim 8, wherein the displacement sensor is an infrared sensing module and the locating diode is an infrared photodiode.

11. The multi-functional wireless control device as claimed in claim 8, wherein the operating body further includes a timer electrically connecting with the control module and configured to set a time to switch the operating body to standby or asleep modes.

12. The multi-functional wireless control device as claimed in claim 8, wherein the operating body further includes a reset key configured to reset the wireless mouse mode.

13. The multi-functional wireless control device as claimed in claim 12, wherein the mouse keys includes a left key, a right key and a roller disposed between the left key and the right key; the shell includes an upper surface, an opposite bottom surface and an end surface disposed therebetween that connecting with the upper surface and the bottom surface; the remote operating keys and the mouse keys are disposed on the upper surface; the switch, reset key and the locating diode are disposed on the bottom surface of the shell; the infrared module and the indicating diode are disposed on the end surface of the shell.

14. A multi-functional wireless control device configured to operate in a remote controlling mode or a wireless mouse mode to control a digital processing device, comprising:
an operating body comprising:
a shell having a plurality of operating keys disposed thereon configured for inputting the corresponding controlling signals and an indicating diode disposed thereon configured to send out visible rays as a projector laser pointer;
a control module assembled within the shell configured to process the inputting controlling signals and establish communication with the digital processing device; and
a switch configured to change the using module between the remote controlling mode and wireless mouse mode.

15. The multi-functional wireless control device as claimed in claim 14, wherein further comprises a receiving unit electrically connecting with a digital port of a digital processing device configured to establish communication between the operating body and the digital processing device.

16. The multi-functional wireless control device as claimed in claim 15, wherein the operating keys includes a set of remote operating keys disposed on a surface of the shell; the operating body further includes an infrared module electrically connecting with the control module and configured to transmit the corresponding controlling signals generated by the remote operating keys to the receiving unit.

17. The multi-functional wireless control device as claimed in claim 16, wherein the operating keys further includes mouse keys, the operating body further includes a transmit module electrically connecting with the control module and configured to transmit the corresponding controlling signals generated by the mouse keys to the receiving unit.

18. The multi-functional wireless control device as claimed in claim 16, wherein the operating body further includes a processing unit assembled within the shell, the processing unit includes a signal channel convertor electrically connecting with the control module and the switch, the signal channel convertor is configured to receive the switching signal generated by the switch to activate the wireless mouse mode and search for the proper signal channel and communicating frequency.

19. The multi-functional wireless control device as claimed in claim 17, wherein the processing unit further includes a mouse key module, and a displacement sensor all electrically connecting with the control module; the mouse key module electrically connects with the mouse keys and is configured to receive the corresponding controlling signals generated thereby; the displacement sensor electrically connects with a locating diode disposed on the bottom surface of the shell to sense the shift of the operating body.
